(19) United States
(12) Patent Application Publication
(10) Pub. No.: US 2002/0163545 A1
(43) Pub. Date: Nov. 7, 2002

(54) Method of previewing web page content while interacting with multiple web page controls

(76) Inventor: Samuel S. Hii, Downers Grove, IL (US)

Correspondence Address: Samuel H. Dworetsky, AT&T CORP., P.O. Box 4110, Middletown, NJ, 07748-4110, US

(21) Appl. No.: 09/846,918

(22) Filed: May 1, 2001

(51) Int. Cl. G09G 5/00

(52) U.S. Cl. 345/838

(57) ABSTRACT

A network client may have a capability to load and maintain more than one active page image. To assist a user in selecting from a number of page images, a graphical display element is provided corresponding to each active page image. When the graphical display element is preliminarily selected, an image including at least a portion of the page image is displayed in a pop-up window. The preliminary selection of the graphical display element may be pausing a mouse pointer over a tab corresponding to a page image.

### FIELD OF THE INVENTION

The present invention relates generally to client software that displays content retrieved from servers in a network, and specifically to such client software capable of loading multiple active web pages that are selectively accessible to a user.

### BACKGROUND OF THE INVENTION

Most browser software available on the market today permits only one web page to be active at a time. In order to view a web page previously viewed during a browsing session, a user must re-direct the browser to that web page, either by retyping the URL or by using a “BACK” or similar instruction in the browser user interface. Depending on the cache management rules in effect for that web page, the browser will either access a server to retrieve another copy of the web page, or will use cached information to reconstruct the web site at the client. In order to load more than one active web page at a time, it is necessary to run more than one instance of the browser, with each instance displaying a different web page.

An example of a user interface 700 for such a browser is shown in FIG. 1. The user interface 700 includes a toolbar area 792 and an HTML display area 791. A web page 751 including text and graphics is presented in the display area. The web page may also include multimedia materials such as animated graphics and sound. The toolbar area 792 includes buttons 793 for performing various functions such as returning to the previous web page (BACK), ceasing retrieval of a web page that has been initiated (STOP), and retrieving a fresh copy of a web page currently being viewed (REFRESH). The toolbar area may also include a region 794 for displaying brand indicia 795 of an Internet service provider through which the browser is accessing the Internet.

With the availability of increased memory and storage capacity within a client machine, several browsers now permit a plurality of web pages to be active simultaneously. Examples of such browsers include Opera (http://www.opera.com) and NetCaptor (http://www.netcaptor.com). Those browsers provide controls for managing multiple web pages on a single screen. In one example, shown in FIG. 2, tabs 252, 253, 254 are provided along a lower portion of the HTML display area 791 of the browser interface 701. The tabs are “attached” to corresponding web pages. Tab 752 is attached to corresponding web page 751, which is displayed in the HTML display area 791. Tabs 753, 754 are attached to web pages that are active, but are not currently displayed in the HTML display area. The term “active” as used herein to describe a web page means a web page that has been retrieved or “loaded” from a network and is maintained in local memory or storage for immediate access.

In the browser user interface 701 shown in FIG. 2, one may access a web page that is not displayed by selecting the corresponding tab. For example, tab 754, corresponding to a web page that is not displayed, may be selected by positioning cursor 760 over the tab 754 and performing some action such as left-clicking a mouse. In response to selection of the tab 754, the currently displayed web page 751 is hidden and the web page corresponding to the selected tab is displayed.

The tabs 752, 753, 754 should quickly and conveniently convey to the user the content of the corresponding web pages. The HTML data transmitted for many web pages includes a page name that the author has provided to identify the page. In the example of FIG. 2, the name of the web page as provided in the HTML code is displayed on the tab. To fit the page name on the tab, a portion of the page name must frequently be truncated. To address that problem, a text-based pop-up window 761 is used to display the full name of the web page. The pop-up window, sometimes referred to as a “tool tip,” is displayed when a user selects the tab in a preliminary manner. In this instance, the tab is selected in a preliminary manner when a user moves a cursor over the tab and pauses for a predetermined period of time. The pop-up window displays the complete page name. In the example shown in FIG. 2, the partial page names displayed on the tabs, e.g. “Web Pa . . . ”, do not reveal the identity of the web page as compared to the other web pages displayed on tabs. The pop-up window, however, permits the user to differentiate between the active web pages.

While the above system solves the problem of displaying incomplete web pages on the tabs, the system relies on the author of the web page to provide a descriptive name for the web page, and relies on the user to associate that particular name with a particular web page. In many instances, especially where a web page is deep within a tree structure, no special name is provided for that web page. In that case, either the URL of the web page or the initial text appearing within the HTML data is displayed. In either case, a user observing the tabs and associated pop-up text windows would have difficulty differentiating between several active web pages within the same tree structure without actually selecting and displaying those web pages one at a time.

Furthermore, names given to web sites by authors may simply not be sufficiently descriptive to refresh a user's memory as to the content of the page. This is especially true in a typical browsing situation where many of the active web pages contain similar subject matter. It is therefore desirable to provide a method for a user to differentiate among active web pages that does not rely on a text description of the contents.

Thumbnail versions of graphical images have been used for simultaneously displaying a number of images for selection by a user. For example, several software archiving software packages display an array of thumbnail representations of stored photographs. A user clicks on one of the thumbnail representations to view a full-sized version of the photo. A similar user interface is found on some web pages, where thumbnail representations of photos are initially downloaded to a client for display. When a user clicks on a thumbnail, a full-sized version is downloaded and displayed.

### SUMMARY OF THE INVENTION

The forgoing problems are solved and a technical advancement is achieved by the method described and claimed herein for displaying a plurality of graphical images. In one embodiment of the invention, a machine readable medium contains configuration instructions for performing a method on a user machine. In the method, the machine first displays a graphical display element representing a graphical image. The machine detects a preliminary selection of the graphical display element, and responsive to detecting preliminary selection of the graphical display element, displays a preview of the graphical image including at least a partial image of the graphical image. The machine then detects a final selection of the graphical display element; and responsive to detecting final selection of the graphical display element, displays the graphical image.

Displaying a preview of the corresponding graphical image may include displaying a thumbnail of the corresponding graphical image, in which case the thumbnail of the corresponding graphical image may be prepared in advance. Alternatively, displaying a preview of the corresponding graphical image may include displaying a portion of the corresponding graphical image. The graphical image may be a web page, and the graphical display element may be a representation of a tab.

In response to detecting a preliminary selection of the graphical display element, the machine may also display a textual indication of the content of the graphical image.

The user machine may include a graphical pointing device. In that case, the preliminary selection of the graphical display element may include placement of a pointer of the graphical pointing device over the graphical display element. Furthermore, final selection of the graphical display element may include depressing a button of the graphical pointing device while a pointer of the graphical pointing device is over the graphical display element.

In another embodiment of the invention, the client machine is connected to a network, and is configured to perform a method of displaying a plurality of graphical images by transmitting configuration instructions through the network to the client machine.

In yet another embodiment, a plurality of graphical images are displayed on a computer display. A graphical display element representing a graphical image is first displayed. A preliminary selection of the graphical display element is detected. Responsive to detecting the preliminary selection of the graphical display element, a preview of the graphical image is displayed including at least a partial image of the graphical image.

That embodiment may also include detecting a final selection of the graphical display element, and responsive to detecting a final selection of the graphical display element, displaying the graphical image.

In a further embodiment, a computer having a graphical pointing device displays a plurality of graphical images. The computer first display a first graphical image, and displays a graphical display element corresponding to a second graphical image. The computer detects a preliminary selection of the graphical display element corresponding to a second graphical image, and, responsive to detecting the preliminary selection of the graphical display element corresponding to a second graphical image, displays a preview of the second graphical image including at least a partial image of the second graphical image.

In that method, the computer may also detect a final selection of the graphical display element corresponding to the second graphical image; and, responsive to the final detection selection of the graphical display element, cease display of the first graphical image and instead display the second graphical image.

The computer may furthermore display a graphical display element corresponding to the first graphical image; detect a preliminary selection of the graphical display element corresponding to a first graphical image, and, responsive to detecting the preliminary selection of the graphical display element corresponding to a first graphical image, display a preview of the first graphical image including at least a partial image of the first graphical image. The computer then detects a final selection of the graphical display element corresponding to the first graphical image and, responsive to detecting the final selection of the graphical display element corresponding to the first graphical image, ceases display of the second graphical image and displays the first graphical image in the display.

In another aspect of the invention, a machine readable medium contains configuration instructions for performing a method of displaying a web page in a client connected to a network. In the method, the client first retrieves a first web page from the network, and displays a graphical display element representing the first web page. The client detects a preliminary selection of the graphical display element, and, responsive to the preliminary selection of the graphical display element, displays a preview of the first web page including at least a partial image of the first web page. The client then detects a final selection of the graphical display element; and, responsive to detecting the final selection of the graphical display element, displays the first web page.

The preliminary selection of the graphical display element may be a cursor of a pointing device moving over the graphical display element, or a cursor of a pointing device pausing over the graphical display element. A second web page may be retrieved and displayed, wherein displaying the first web page includes replacing the second web page with the first web page. Final selection of the graphical display element may include an actuation of a button while a cursor of a pointing device is over the graphical display element. The method may also include receiving configuration instructions from a user, and configuring the preview according to the instructions. The at least partial image of the first web page may be a cropped image of the web page, or may be a thumbnail image of the web page.

These and other advantages of the invention will be apparent to those of ordinary skill in the art by reference to the following detailed description and the accompanying drawings.

### BRIEF DESCRIPTION OF THE DRAWINGS

FIG. 1 illustrates a prior art browser user interface displaying a single web page.

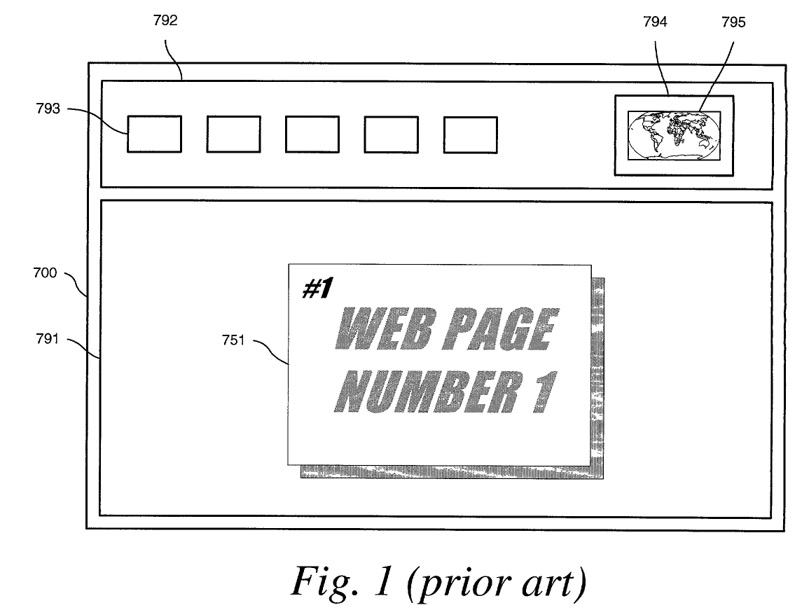

FIG. 2 illustrates a prior art browser user interface displaying a plurality of web pages that are indexed using tabs.

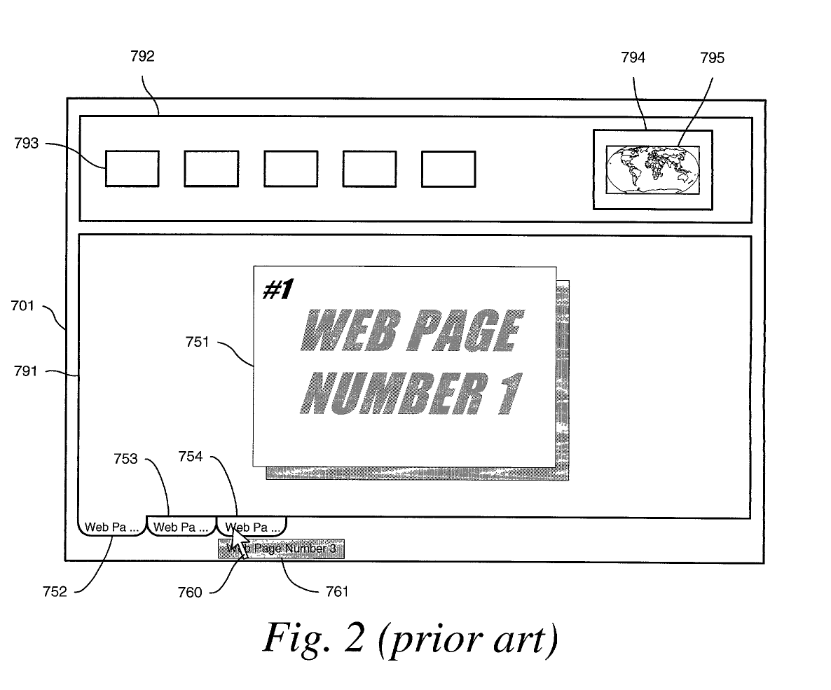

FIG. 3 illustrates a client user interface of the invention displaying a plurality of web pages that are indexed using tabs and previewing one of those web pages.

FIG. 4 illustrates a method of the invention showing how a web page is retrieved and displayed.

FIG. 5 illustrates another browser user interface of the invention displaying a plurality of web pages that are indexed using tabs and previewing one of those web pages.

FIG. 6 is a set-up window for configuring the web page preview in accordance with the present invention.

FIG. 7 illustrates a method of the invention for previewing web pages before selection.

### DETAILED DESCRIPTION

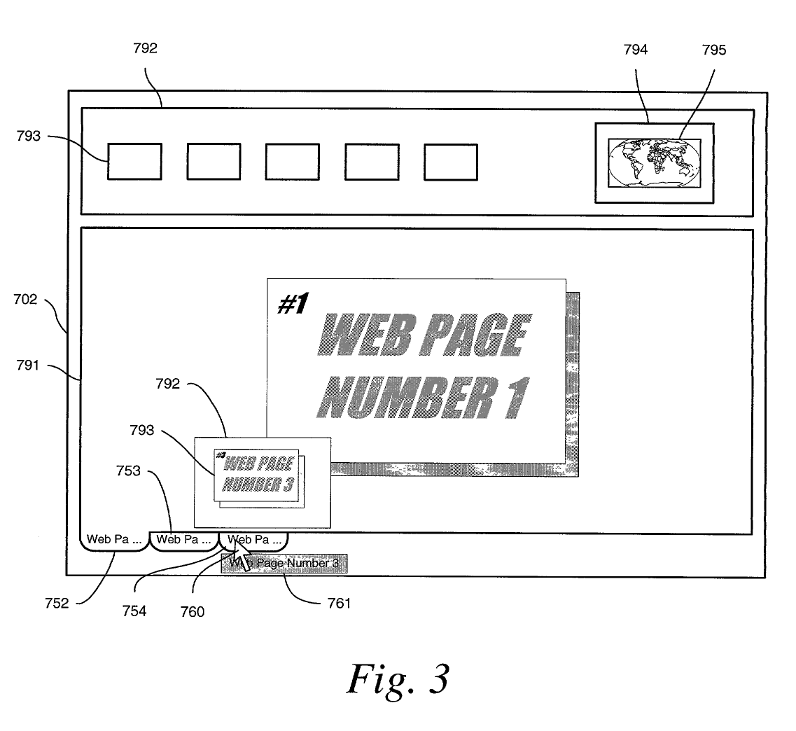

FIG. 3 illustrates an example of a client user interface 702 in accordance with a preferred embodiment of the invention. The client is displaying a graphical image entitled “Web Page Number 1” in its HTML display area 791. In the illustrated example, the graphical image is a web page, although other graphical images, such as photos, maps and images of text-based documents, may also be displayed in accordance with the invention. A series of graphical display elements, in this case tabs 752, 753, 754, are positioned across the bottom of the client user interface 702. Each of the tabs corresponds to a web page that has been previously loaded by the browser. It should be understood that graphical display elements 752, 753, 754 need not be tabs, but instead may be other elements such as icons or menu buttons.

A pointer 760 controlled by a graphical pointing device such as a mouse, track ball or touch pad is shown paused over tab 754, corresponding to a web page entitled “Web Page Number 3.” The tab 754 is labeled “Web Pa . . . ” which is a truncated form of “Web Page Number 3.” The titles of the web pages in this example are presumed to have been assigned by the author. Above the tab is a preview 793 of the web page entitled, “Web Page Number 3” which was previously loaded by the browser and is present in memory in the client machine. In this case the preview 793 is a thumbnail or miniature version of the web page. The thumbnail version 793 of the web page is in a pop-up window 792 that appeared as a result of placing the pointer 760 over the tab 754. The pop-up window 792 may appear as soon as the pointer 760 moves over the tab 754, or may appear after the pointer has paused over the tab for a predetermined minimum time.

In the embodiment shown in FIG. 3, the pop-up window 792 occupies a portion of the HTML display area 791 of the browser interface 702. In a preferred embodiment, the pop-up window 792 is displayed adjacent the tab so as to quickly make apparent the tab with which the window is associated. Alternatively, the pop-up window may be placed above or below the display area so as not to obstruct the HTML display.

As the pointer is moved from one tab to another, the pop-up window changes. For example, a miniature or thumbnail of “Web Page Number 2” is displayed in the pop-up window when the pointer is over tab 753. As the pointer is moved along the row of tabs, the pop-up window of a previous tab disappears and a pop-up window of a new tab appears. In the preferred embodiment, both the location and content of the pop-up window change as the pointer is moved from tab to tab.

The alternative steps of moving a cursor over a graphical display element or pausing the cursor over the element are referred to herein as making a preliminary selection of a graphical display element. Other means of making such a preliminary selection of a graphical display element include right-clicking while the cursor is over the element, performing a keystroke while the cursor is over the element, touching a touch screen location displaying the element or using any other input device to signal the computer that a given graphical display element is of interest. In contrast to making a preliminary selection of a graphical display element, a final selection of such an element results in displaying the corresponding web page. An example of making a final selection is left-clicking a tab corresponding to a desired web page.

Returning to the embodiment of the invention shown in FIG. 3, in addition to displaying a pop-up window 792 containing a preview 793 of the corresponding web page, the invention may also display a text window 761 upon preliminary selection of the graphical display element. The text window may contain the name of the corresponding web page, or may contain the URL or the initial text found in the HTML document. Alternatively, the user may manually input text to describe the corresponding web page. For example, a user may have several web pages load automatically each time the browser is started. A user may assign meaningful names to those web pages and have those names appear in a text pop-up window when the pointer is placed over a tab.

In a preferred embodiment, the pop-up preview window 792 is displayed during the time when a tab 754 is preliminarily selected, and ceases to be displayed when the tab ceases to be preliminarily selected, or when another tab is preliminarily selected. The complete HTML viewing area is therefore easily recovered by moving the cursor off a tab. That feature also permits a user to quickly locate a loaded web page by moving the cursor along a row of tabs, sequentially displaying representations of the loaded web pages as the cursor moves.

Alternatively, the pop-up window 792 containing web page preview 793 may remain on the screen after the cursor is moved to another tab, or to another portion of the display. In this manner, several web page previews may be displayed simultaneously, permitting a user to compare them. The web page previews may also be displayed for a predetermined period of time after the cursor is removed from the tab, then fading or disappearing from the display, imparting an effect of movement to the successive preview windows.

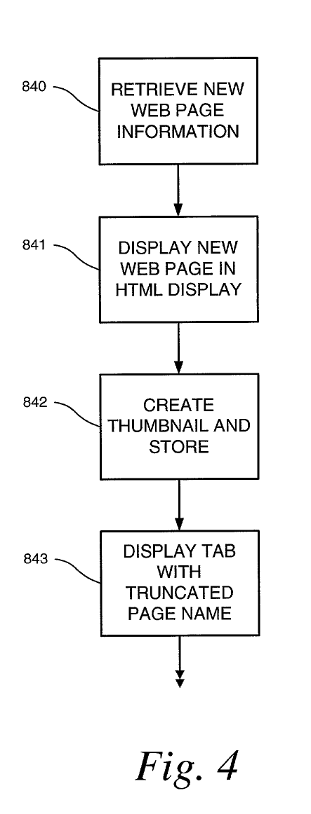

The miniature or thumbnail versions of web pages that are displayed in pop-up windows may be prepared immediately after loading a web page from the network so as to enhance response time of the user interface when later called upon to display a preview. A process for loading a web page according to the invention is shown in FIG. 4. The HTML data describing the web page is first retrieved from the network at step 840. Such retrieval is ordinarily done in response to a user command, but may also be done automatically; e.g. at start-up or periodically. Once the web page is retrieved, it is displayed (step 841) in the HTML display area of the browser user interface. If another web page is currently displayed in the HTML display window, that page is removed as the new page is displayed.

After the client loads a new web page, the client prepares (step 842) a thumbnail representation of the web page for later display as described above. All links, animations and other applets are removed before creating the thumbnail. The thumbnail may be a reduced-resolution representation of the HTML page stored as a bitmap image. An uncompressed format is preferred for fast response to the preselection of a tab.

A tab or other graphical display element is displayed (step 843) to permit the user to recall the retrieved web page. As is known in the art, the tab is preferably displayed at an edge of the screen so as not to block the HTML display area of the browser. A title of the corresponding web page, or a truncated version of the title if space is limited, is displayed on the tab. The tab or other graphical display element is selected for displaying its associated web page by, for example, moving a mouse pointer over the element and clicking the mouse.

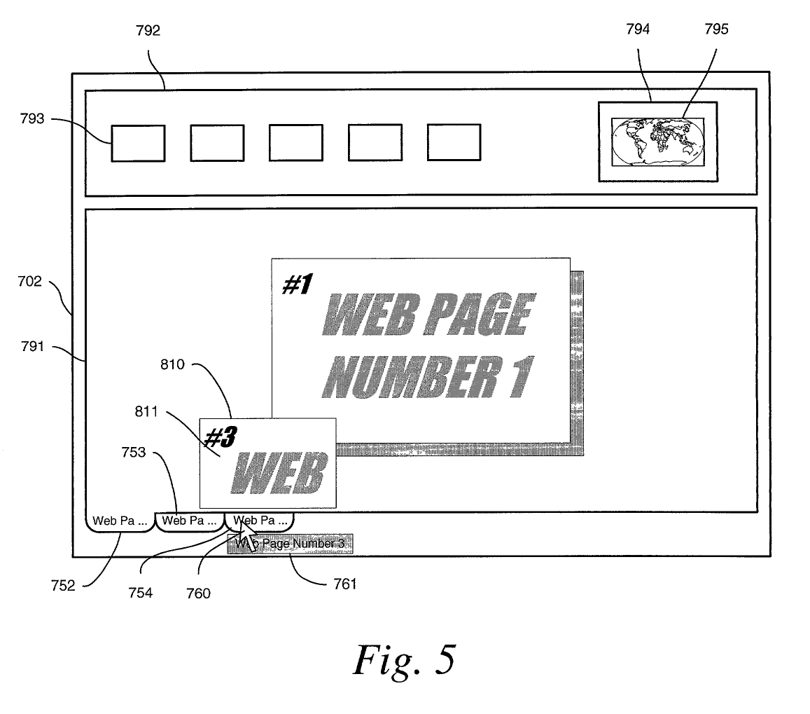

An alternative version of the preview window, shown in FIG. 5, contains a portion of the complete web page instead of a thumbnail version of the complete web page. In the illustrated example, the preview window 810 contains a portion 811 of the corresponding web page consisting of the upper left corner. Because the preview image 811 is simply a cropped version of the complete web page, the preview need not be prepared ahead of time as with the thumbnail preview. The preview 811 is advantageously used where identifying characteristics of the loaded web pages may be found in a consistent region of the page, such as the upper, left-hand corner as shown in FIG. 5.

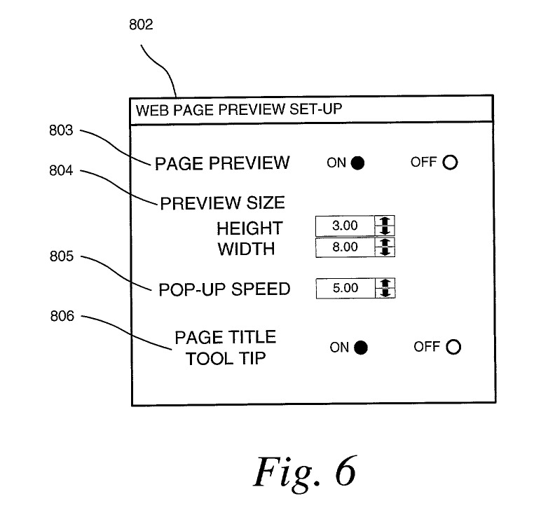

A user may set parameters controlling various characteristics of the pop-up window. FIG. 6 shows an example of a set-up window 802 for controlling several characteristics of the pop-up window. The menu of the set-up window 802 includes a selection 803 for turning the page preview on or off. A user may wish to deactivate the page preview in situations where the titles of the pages are sufficient to differentiate among the loaded pages. Additionally, the size 804 of the preview window may be set to a user's individual preference. In this way, a user may optimize between the clarity of the preview and the space taken up in the HTML display area. Similarly, the speed 805 that the window appears may be adjusted by changing the time that the pointer must pause before the preview appears. Finally, a menu item 806 activates and deactivates the tool tip window, which a user may or may not prefer to have displayed with the page preview.

Other characteristics of the page preview may also be user-configurable. For example, the preview shape may be changeable between the rectangular shape shown and a circular or oval shape (not shown). Additionally, the user may have control over the brightness of the image in the preview and the relative position of the preview with respect to the tab. In the case of a preview that is a partial view of the page, a user may control the location of the partial view within the page (e.g., top left).

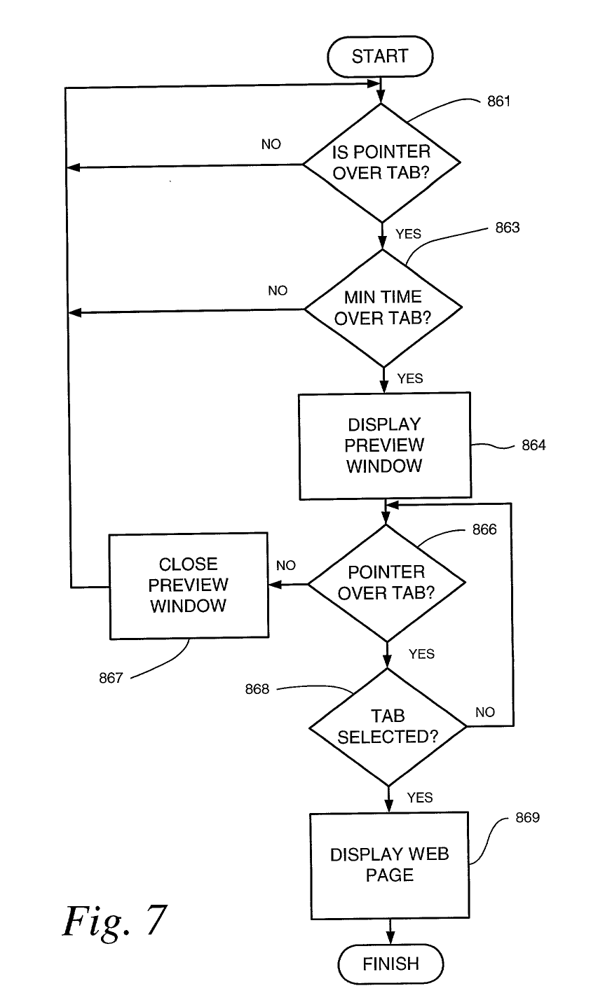

A method for displaying a graphical image in accordance with the invention is shown in FIG. 7. The method is performed by a user machine or computer having a central processing unit, a memory and a user interface including at least a display screen. The user machine is configured to perform the method by loading instructions contained in a machine readable medium such as a floppy disk, a fixed disk, tape or durable memory such as EPROM. Alternatively, the machine may be configured by downloading the instructions over a network such as the Internet.

The client software monitors the system to detect a preliminary selection of the graphical display element. In the illustrated example, the system monitors the position of the pointer of a graphical pointing device. If the pointer is found to be over a graphical display element (decision block 861) such as a tab representing a loaded web page, the client next determines whether the pointer has paused for longer than a predetermined time, shown as decision block 863. Once both conditions are met, the client displays (step 864) a preview window including at least a partial image of the corresponding web page.

The client continues to monitor the position of the pointer to determine whether the pointer has moved from over the graphical display element. If the pointer has moved away from a position over the tab (decision block 866), the preview window is closed (block 867) and the process starts over. If the pointer remains on the graphical display element, the preview window remains displayed and the client checks whether the user has made a final selection of the element, as shown by decision block 868. Final selection of the element is made, for example, by “clicking” on it with a mouse.

Upon final selection of a graphical display element, a web page corresponding to that element is displayed in the client HTML display area. The preview window is closed simultaneously. Any web page previously displayed is “covered” by the newly selected web page, but can be redisplayed by selected the corresponding graphical display element.

In the above-described method, the graphical display element is preselected by moving a mouse pointer over a tab, and then pausing the pointer over the tab. One skilled in the art would recognize that other actions by the user could define preselection of a graphical display element. For example, a mouse pointer could simply be moved over the graphical display element, without pausing. Alternatively, keystrokes identifying the graphical display element, such as depressing “1” for a first tab, could be used. Similarly, actions other than a mouse click, such as keystrokes or double-clicking, could be used to represent final selection of a graphical display element.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description describes an embodiment of the invention with particular reference to a client browser accessing the Internet. However, the principles of the present invention could be readily extended to other software displaying a number of graphical images one at a time. For example, software displaying a collection of photographs or drawings could benefit from use of the method of the invention. Such an extension could be readily implemented by one of ordinary skill in the art given the above disclosure.

What is claimed is:

1. A machine readable medium containing configuration instructions for performing a method on a user machine, the method comprising the steps of:
displaying a graphical display element representing a graphical image;
detecting a preliminary selection of the graphical display element;
responsive to detecting the preliminary selection of the graphical display element, displaying a preview of the graphical image including at least a partial image of the graphical image;
detecting a final selection of the graphical display element; and
responsive to detecting the final selection of the graphical display element, displaying the graphical image.

2. The machine readable medium as claimed in claim 1, wherein said step of displaying a preview of the corresponding graphical image comprises displaying a thumbnail of the corresponding graphical image.

3. The machine readable medium as claimed in claim 2, wherein the method further comprises the step of preparing a thumbnail of the corresponding graphical image.

4. The machine readable medium as claimed in claim 1, wherein said step of displaying a preview of the corresponding graphical image comprises displaying a portion of the corresponding graphical image.

5. The machine readable medium as claimed in claim 1, wherein the graphical image is a web page.

6. The machine readable medium as claimed in claim 1, wherein the graphical display element is a representation of a tab.

7. The machine readable medium as claimed in claim 1, wherein the method further comprises, in response to detecting the preliminary selection of the graphical display element, displaying a textual indication of the content of the graphical image.

8. The machine readable medium as claimed in claim 1, wherein the user machine comprises a graphical pointing device, and the preliminary selection of the graphical display element comprises placement of a pointer of the graphical pointing device over the graphical display element.

9. The machine readable medium as claimed in claim 1, wherein the user machine comprises a graphical pointing device, and the final selection of the graphical display element comprises depressing a button of the graphical pointing device while a pointer of the graphical pointing device is over the graphical display element.

10. A method of configuring a client machine connected to a network, the method comprising transmitting configuration instructions through the network to the client machine for performing a method of displaying a plurality of graphical images, the method of displaying comprising the steps of:
displaying a graphical display element representing a graphical image;
detecting a preliminary selection of the graphical display element;
responsive to detecting the preliminary selection of the graphical display element, displaying a preview of the graphical image including at least a partial image of the graphical image;
detecting a final selection of the graphical display element; and
responsive to detecting the final selection of the graphical display element, displaying the graphical image.

11. The method as claimed in claim 10, wherein said step of displaying a preview of the corresponding graphical image comprises displaying a thumbnail of the corresponding graphical image.

12. The method as claimed in claim 11, further comprising the step of preparing a thumbnail of the corresponding graphical image.

13. The method as claimed in claim 10, wherein said step of displaying a preview of the corresponding graphical image comprises displaying a portion of the corresponding graphical image.

14. The method as claimed in claim 10, wherein the graphical image is a web page.

15. The method as claimed in claim 10, wherein the graphical display element is a representation of a tab.

16. The method as claimed in claim 10, further comprising, in response to detecting the preliminary selection of the graphical display element, displaying a textual indication of the content of the graphical image.

17. The method as claimed in claim 10, wherein the client machine comprises a graphical pointing device, and the preliminary selection of the graphical display element comprises placement of a pointer of the graphical pointing device over the graphical display element.

18. The method as claimed in claim 10, wherein the client machine comprises a graphical pointing device, and the final selection of the graphical display element comprises depressing a button of the graphical pointing device while a pointer of the graphical pointing device is over the graphical display element.

19. A method of displaying a plurality of graphical images on a computer display, comprising the steps of:
displaying a graphical display element representing a graphical image;
detecting a preliminary selection of the graphical display element; and
responsive to detecting the preliminary selection of the graphical display element, displaying a preview of the graphical image including at least a partial image of the graphical image.

20. The method as claimed in claim 19, further comprising the steps of:
detecting a final selection of the graphical display element; and
responsive to detecting the final selection of the graphical display element, displaying the graphical image.

21. The method as claimed in claim 19, wherein said step of displaying a preview of the corresponding graphical image comprises displaying a thumbnail of the corresponding graphical image.

22. The method as claimed in claim 21, further comprising the step of preparing a thumbnail of the corresponding graphical image.

23. The method as claimed in claim 19, wherein said step of displaying a preview of the corresponding graphical image comprises displaying a portion of the corresponding graphical image.

24. The method as claimed in claim 19, wherein the graphical image is a web page.

25. The method as claimed in claim 19, wherein the graphical display element is a representation of a tab.

26. The method as claimed in claim 19, further comprising, in response to detecting the preliminary selection of the graphical display element, displaying a textual indication of the content of the graphical image.

27. The method as claimed in claim 19, wherein the preliminary selection of the graphical display element comprises placement of a pointer of a graphical pointing device over the graphical display element.

28. The method as claimed in claim 20, wherein the final selection of the graphical display element comprises depressing a button of a graphical pointing device while a pointer of the graphical pointing device is over the graphical display element.

29. A method for displaying a plurality of graphical images using a computer having a graphical pointing device, comprising the steps of:
displaying a first graphical image;
displaying a graphical display element corresponding to a second graphical image;
detecting a preliminary selection of the graphical display element corresponding to a second graphical image;
responsive to detecting the preliminary selection of the graphical display element corresponding to a second graphical image, displaying a preview of the second graphical image including at least a partial image of the second graphical image.

30. The method as claimed in claim 29, further comprising the steps of:
detecting a final selection of the graphical display element corresponding to the second graphical image; and
responsive to the final detecting selection of the graphical display element, ceasing display of the first graphical image and displaying the second graphical image.

31. The method as claimed in claim 30, further comprising the steps of:
displaying a graphical display element corresponding to the first graphical image;
detecting a preliminary selection of the graphical display element corresponding to a first graphical image;
responsive to detecting the preliminary selection of the graphical display element corresponding to a first graphical image, displaying a preview of the first graphical image including at least a partial image of the first graphical image;
detecting a final selection of the graphical display element corresponding to the first graphical image; and
responsive to detecting the final selection of the graphical display element corresponding to the first graphical image, ceasing display of the second graphical image and displaying the first graphical image in the display.

32. A machine readable medium containing configuration instructions for performing a method of displaying a web page in a client connected to a network, the method comprising the steps of:
retrieving a first web page from the network;
displaying a graphical display element representing the first web page;
detecting a preliminary selection of the graphical display element;
responsive to the preliminary selection of the graphical display element, displaying a preview of the first web page including at least a partial image of the first web page;
detecting a final selection of the graphical display element; and
responsive to detecting the final selection of the graphical display element, displaying the first web page.

33. The machine readable medium as claimed in claim 32, wherein the preliminary selection of the graphical display element comprises a cursor of a pointing device moving over the graphical display element.

34. The machine readable medium as claimed in claim 32, wherein the preliminary selection of the graphical display element comprises a cursor of a pointing device pausing over the graphical display element.

35. The machine readable medium as claimed in claim 32, wherein the method further comprises the step of retrieving and displaying a second web page, and wherein the step of displaying the first web page includes replacing the second web page with the first web page.

36. The machine readable medium as claimed in claim 10, wherein the final selection of the graphical display element comprises an actuation of a button while a cursor of a pointing device is over the graphical display element.

37. The machine readable medium as claimed in claim 32, wherein the method further comprises the steps of receiving configuration instructions from a user, and configuring the preview according to the instructions.

38. The machine readable medium as claimed in claim 32, wherein the at least partial image of the first web page is a cropped image of the web page.

39. The machine readable medium as claimed in claim 32, wherein the at least partial image of the first web page is a thumbnail image of the web page.
